(19) United States
(12) Patent Application Publication
(10) Pub. No.: US 2013/0293680 A1
(43) Pub. Date: Nov. 7, 2013

(54) Arrangement and Method for Timber Rotation

(71) Applicant: Tommi Ilkka Dillström, Tallinn (EE)

(72) Inventor: Tommi Ilkka Dillström, Tallinn (EE)

(73) Assignee: VISIOMETRIC OU, Tallin (EE)

(21) Appl. No.: 13/980,198

(22) PCT Filed: Jan. 10, 2012
(86) PCT No.: PCT/IB12/00020

§ 371 Date: Jul. 17, 2013

(30) Foreign Application Priority Data
Jan. 20, 2011 (EE) P201100006

(51) Int. Cl. H04N 7/18

(52) U.S. Cl. CPC H04N 7/18
USPC 348/46

(57) ABSTRACT

The present invention relates to an arrangement and a method for monitoring progress of timber rotation before sawing machine in a sawmill. This aim is reached by providing a separate 3D-rotation scanner which identifies the previously 3D-scanned and measured log and which measures the rotation progress in the log turner in real time. Accordingly to the method, the already scanned and measured timber (log) is scanned again with additional 3D-rotation scanner and the newly scanned position of the timber is compared with the parameters of the previously scanned data and accordingly the process of the timber (log) rotation can be evaluated in real time. As a result, it is monitored if the timber (log) is turned into an optimized position before entering sawing machine and if there is a need of correction of the timber's (log's) position, the scanner will instruct the log turner or the operator to do so.

### TECHNICAL FIELD

The present invention relates to an arrangement and a method for monitoring progress of timber rotation before sawing machine in a sawmill.

### PRIOR ART

In order to minimize the loss of quality timber during the processing logs in a sawmill, logs are scanned and monitored in order to measure, evaluate their quality and rotate the logs for optimal cutting. Timber rotation is conventionally done manually by an operator using a joystick or electronically/mechanically using the assistance of 3D-scanner and log turner. This arrangement is used for example by Comact Equipment Inc (Canada), the arrangement used can be viewed here: http://www.woodproductsonlineexpo.com/content.php/38/108/comact_full_profile_scanner.html.

The problem with the prior art solutions is that there is potential risk of errors for determining the optimal rotation of the timber. Although timber is scanned with 3D-scanner and the information is transferred to the log turner, there may be additional factors during the transportation of the timber on a conveyor which disturb the initially scanned alignment of the timber. Accordingly the problems with log rotation in a mechanical forest industry are that optimal log's position can be disturbed by normal depreciation of the mechanics, different sides of the log may have different conditions (for example ice) and knots or irregularities of the log may stick to the parts of the machinery. This will cause unnecessary mechanical problems, loss of timber and loss of sawing quality during the sawing process.

### SUMMARY OF THE INVENTION

It is an aim of the invention to provide an arrangement which monitors and if necessary adjusts timber rotation before it enters sawing machine.

This aim is reached by providing a separate 3D-rotation scanner which identifies the previously 3D-scanned and measured log and which measures the rotation progress in the log turner in real time. The 3D-rotation scanner is positioned in a proximate position before or after the log turner.

It is another aim of the invention to provide improved method for which monitoring and if necessary improving timber rotation before it enters sawing machine.

Accordingly to the method, the already scanned and measured timber (log) is scanned again with additional 3D-rotation scanner in a proximate position before or after the log turner. The newly scanned position of the timber is compared with the parameters of the previously scanned data and accordingly the process of the timber (log) rotation can be evaluated in real time. As a result, it is monitored if the timber (log) is turned into an optimized position before entering sawing machine and if there is a need of correction of the timber's (log's) position, the scanner will instruct the log turner or the operator to do so.

The arrangement and method makes the process of timber handling more precise, easier and faster.

### BRIEF DESCRIPTION OF THE DRAWINGS

FIG. 1 depicts general layout of the arrangement accordingly to the invention.

FIG. 2 depicts general layout of the alternative embodiment of the invention.

### DETAILED DESCRIPTION OF EMBODIMENTS

The invention will now be described in more detail with examples of embodiments and with reference to the figures attached.

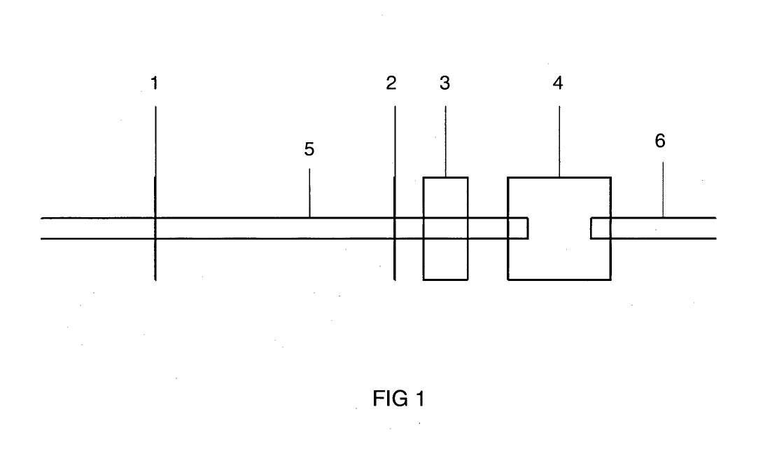

FIG. 1 depicts a general layout of the arrangement accordingly to the invention. Timber (log) is first measured with 3D-log scanner 1 in longitudinal conveyor 5.

3D-log scanner 1 optimizes rotation angle for log and log turner 3 rotates log into the optimized position. During rotation, 3D-rotation scanner 2 indentifies the log scanned previously by the 3D-log scanner 1 as the log may have changed its position during the transportation process on longitudinal conveyor 5. 3D-rotation scanner 2 measures the rotation progress of log in real time. Rotation ends when 3D-rotation scanner 2 detects correct position of rotation. The log is then moved into sawing machine 4 and transported further as block by a longitudinal conveyor 6. The whole operation is based on fact that logs have individual 3D-shape and in principle every cross-section of a log has individual shape. As a result, it is monitored by the 3D-rotation scanner 2 if the log is turned into an optimized position by the log turner 3 before entering sawing machine 4 and if there is a need of correction of the log's position, the 3D-rotation scanner 2 will instruct the log turner 3 or the operator to do so.

The 3D-rotation scanner 2 is positioned in a proximate position before or after the log turner 3.

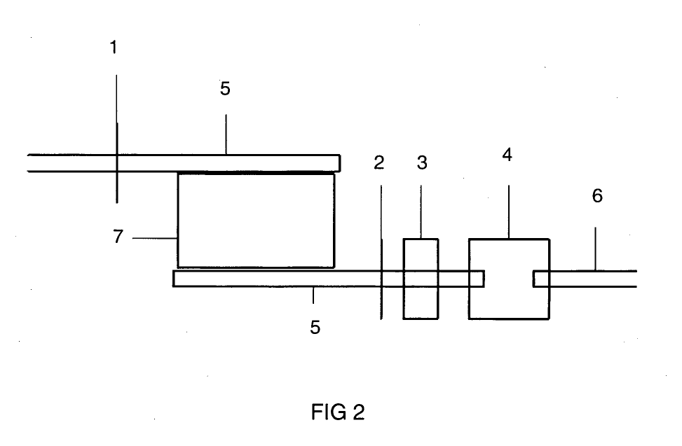

Accordingly to alternative embodiment of the invention, the optimized log rotation can be achieved also with lay-outs with sideways conveyor 7 as depicted on FIG. 2. In this embodiment the 3D-rotation scanner 2 is positioned in a proximate position after the log turner 3.

Accordingly to the invention, the 3D-rotation scanner 2 can correct rotation even if log has rotated after 3D-log scanner 1 and correct measurement even if knots or other mechanical issues interfere rotation.

It is likewise stated in the description that measurement is performed on a piece of timber. The invention obviously works just as well in monitoring rotation progress of an object of some other shape or of a material other than wood. The invention must thereby be regarded as being limited only by the scope of the patent claims below.

What is claimed is:

1. Arrangement for timber rotation in a sawmill comprising a 3D-log scanner, a first longitudinal conveyor, a log tuner, a sawing machine, a second longitudinal conveyor and optionally a sideways conveyor, wherein a 3D-rotation scanner is provided in a proximate position of the log turner.

2. The arrangement according to claim 1, wherein the 3D-rotation scanner is positioned in a proximate position before the log turner.

3. The arrangement according to claim 1, wherein the 3D-rotation scanner is positioned in a proximate position after the log turner.

4. A method for log rotation in a sawmill with a 3D-rotation scanner according to claim 1, wherein the 3D-rotation scanner measures the rotation progress of a log.

5. The method according to claim 4, wherein the 3D-rotation scanner measures the rotation progress of a log in real time.

6. The method according to claim 4, wherein the 3D-rotation scanner instructs the log turner to adjust rotation.

7. The method according to claim 4, wherein the 3D-rotation scanner instructs operator to adjust rotation.

8. The method according to claim 4, wherein rotation ends when the 3D-rotation scanner detects correct position of the rotation.

9. The method of claim 4, wherein the 3D-rotation scanner is positioned in a proximate position before the log turner.

10. The method of claim 4, wherein the 3D-rotation scanner is positioned in approximate position after the log turner.

11. The method of claim 5, wherein the 3D-rotation scanner instructs the log turner to adjust rotation.

12. The method of claim 5, wherein the 3D-rotation scanner instructs operator to adjust rotation.

13. the method of claim 5 wherein rotation ends when the 3D-rotation scanner detects correct position of the rotation.

14. The method of claim 6, wherein rotation ends when the 3D-rotation scanner detects correct position of the rotation.

15. The method of claim 7, wherein rotation ends when the 3D-rotation scanner detects correct position of the rotation.
